(19) United States
(12) Patent Application Publication
(10) Pub. No.: US 2022/0104472 A1
(43) Pub. Date: Apr. 7, 2022

(54) AUTONOMOUS BAIT

(71) Applicant: Pure Fishing, Inc., Spirit Lake, IA (US)

(72) Inventors: Benjamin Parker, Chardon, OH (US); William Eugene Rabbitt, Chesterland, OH (US); Robert F. Soreo, Cleveland Heights, OH (US)

(21) Appl. No.: 17/449,981

(22) Filed: Oct. 5, 2021

Related U.S. Application Data
(60) Provisional application No. 63/088,071, filed on Oct. 6, 2020.

(51) Int. Cl. A01K 85/16

(52) U.S. Cl. CPC A01K 85/16

(57) ABSTRACT

An autonomous, artificial bait aims to simulate the movements of natural baits. The autonomous bait may be designed to appear as a natural bait such as a crawfish, shrimp, worm, or minnow. The autonomous bait includes a cavity in which a gas producing engine may be received. The gas producing engine includes a gas producing agent that produces gas when it interacts with water. That way, when water enters the gas producing engine, gas may be produced that interacts with the autonomous bait to cause movement of the bait that simulates the movements of a natural bait it aims to imitate.

### CROSS-REFERENCE TO RELATED APPLICATIONS

This application claims the benefit of the filing date of U.S. Provisional Application Ser. No. 63/088,071 filed Oct. 6, 2020, entitled, “Autonomous Bait,” the entirety of which is hereby incorporated by reference as if fully set forth herein.

### BACKGROUND OF THE INVENTION

Fishing baits are used to help anglers catch fish. They are typically attached to an end of a fishing line and are designed to attract a fish to bite on a hook attached to the fishing baits. Anglers use one of a natural bait or an artificial bait to attract fish.

Natural, or live, baits are effective because they have a familiar texture, odor, and color to fish. Further, especially when live, natural baits can mimic movements that are natural to fish prey. Anglers use many sources for natural baits, including but not limited to: earthworms, minnows, grubs, maggots, grasshoppers, crickets, bees, aquatic snails, small frogs, tadpoles, crayfish, and even ants.

Unfortunately, natural baits have some downsides. First, they can be a hassle to obtain. They require either foraging for live bait or finding a store that sells live bait. In both cases, the natural bait must be acquired shortly before fishing. This can be inconvenient or even challenging at times. Furthermore, natural baits are inherently “single use” products. Natural bait can be consumed by fish (whether caught or not), or it can fall off a hook during the repetitive cast and reel fishing process, at which time it needs to be replaced. As a result of some of the inconveniences associated with natural baits, many anglers have turned to artificial baits.

Artificial fishing baits are designed to simulate or resemble a natural food source (e.g., a bait fish) for fish both in appearance and in movement as the baits move through the water. The artificial baits are often made of a plastic or a rubber material and thus can be used multiple times over. While artificial baits are made to imitate prey or prey characteristics such as color, flash, or shape, it is quite difficult to reproduce the natural movements of natural bait. Artificial baits include undulations, recesses, and projections that may interact with water to simulate natural movement. However, such movement is dependent on the bait's surrounding, and it cannot independently move. Some baits have incorporated electronics to simulate movement, but those baits are subject to breaking easily and often generate noise that is unnatural and makes fish skeptical.

### SUMMARY OF THE INVENTION

The autonomous bait described herein provides an artificial bait designed to simulate the movements generated by natural baits. The autonomous bait may be made of plastic and/or rubber and be designed to appear similarly to a natural bait (e.g., crawfish, worms, shrimp, or minnows).

The autonomous bait may include one or more cavities in which a gas producing engine may be received and secured. The gas producing engine may be generally formed in one embodiment as a hollow cylindrical tube in which a gas producing agent, such as calcium hydride or CaH2, may be contained. When water enters the engine via an orifice at an end portion of the engine, the water may react with the gas producing agent to create a gas that may similarly exit the engine via the orifice.

The autonomous bait preferably includes portions that are positioned such that when the gas is released from within the engine, it may contact those portions of the bait, thus causing one or more portions of the bait to move relative to other portions of the bait that are not directly contacted by the released gas. Those portions can cause movement of the bait to simulate the natural movements of a live food source in order to attract fish to the bait.

In some embodiments, counterweights may be provided in the body of the autonomous bait to further influence movements of the bait. Similarly, in some embodiments, for example when the bait aims to reproduce movements of a worm, more than one engine may be provided so that additional movement is provided in the autonomous bait.

Generally, the engines are design for single use, and may be disposed of when the gas releasing agent is spent. Alternatively, they may be refillable with a gas producing agent so that they can be used again.

### BRIEF DESCRIPTION OF THE DRAWINGS

FIG. 1 is a schematic depiction of a first embodiment of an autonomous bait.

FIG. 2 is a transparent view of an engine for use in the autonomous bait of FIG. 1.

FIG. 3 is a perspective view of the engine of FIG. 2 with a cap member thereof removed.

FIG. 4 is a schematic illustrating the engine of FIGS. 2 and 3 producing gas in water.

FIGS. 5-7 illustrate various stages of movement of the autonomous bait of FIG. 1.

FIG. 8 is a plan view of a second embodiment of autonomous bait.

FIG. 9 is a plan view of a third embodiment of autonomous bait.

FIG. 10 is an enlarged view of a portion of the autonomous bait of FIG. 9.

FIG. 11 is a plan view of a fourth embodiment of autonomous bait.

FIG. 12 illustrates the autonomous bait of FIG. 11 attached to a fishing swivel and fishing line.

### DETAILED DESCRIPTION

The invention provides an artificial bait system that can be used to catch fish. Portions of the bait may be directly contacted by gas (or another propellant force) released from an engine secured within the bait. When the gas from the engine contacts various portions of the bait, it may cause one or more portions of the bait to move relative to other portions of the bait that are not directly contacted by the released gas. This movement of the bait generated by the bait and gas produced within the bait may mimic the natural movements of a live food source in order to attract fish to the bait.

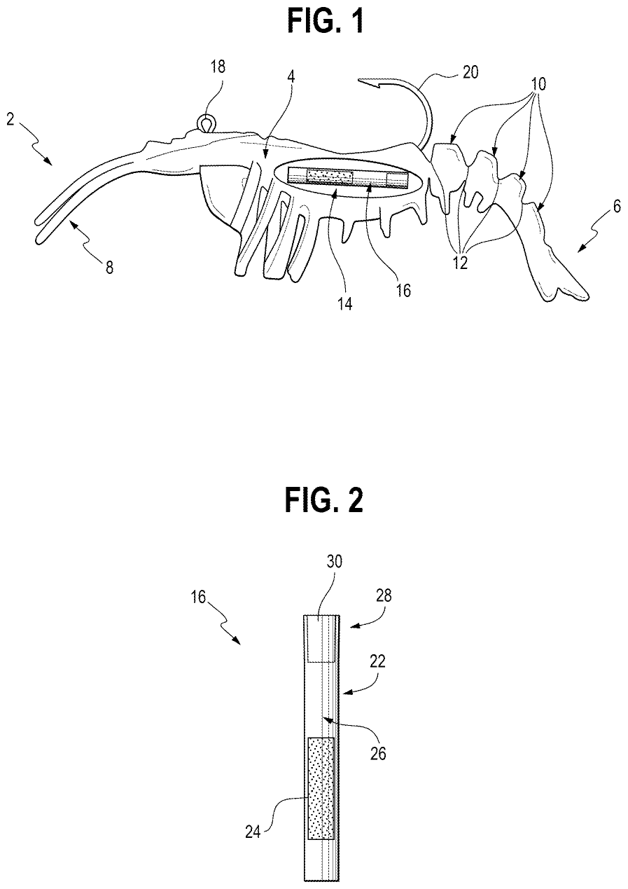

The autonomous bait can take on a number of different shapes, sizes, and configurations so as to mimic natural prey (worm, minnow, crawfish, etc.). The bait may be made from materials including a polymer material, e.g. plastic and/or rubber, or other materials. FIG. 1 depicts an artificial crawfish 2. The crawfish 2 includes a main body 4, tail portion 6, and head portion 8. The tail portion 6 includes segments 10 moveably attached at joints 12 in series relative to the main body 4, such that the segments 10 can move relative to the each other and to the main body 4. The segments 10 are specifically sized and dimensioned and include the joints 12, so as to allow for a high degree of flexibility and motion in the crawfish 2.

The main body 4 also preferably includes a cavity 14 configured to contain an engine 16 therein. The cavity 14 includes an opening (not illustrated) through which the engine 16 can be inserted into and received the cavity 14. The engine 16 can thus be selectively inserted into, and removed from within, the cavity 14. The cavity 14 may be sized and shaped so as to house the engine 16 of a particular size and shape. However, in some embodiments, the cavity 14 may have a size and shape that houses a variety of alternative engine sizes and shapes. The crawfish 2 may also include a ring 18 for to which a fishing line may be tied or otherwise coupled, and a hook 20 like those long known in the art for catching fish.

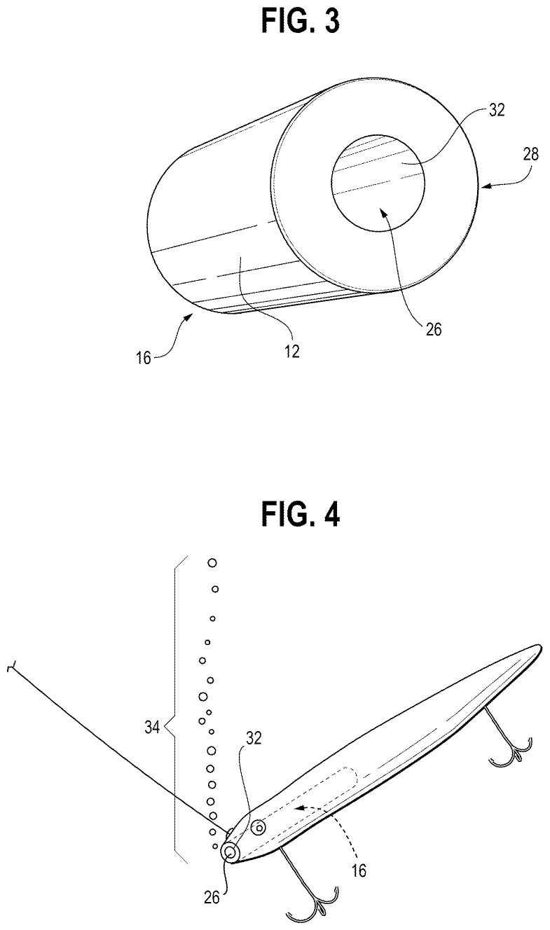

The engine 16, illustrated in FIG. 2, may generally be comprised of a hollow tubing 22, preferably made of a plastic. The tubing 22 may be substantially cylindrical, though other shapes designed to be received within the cavity 14 or a similarly structured cavity are envisioned. A gas producing agent 24 (e.g. calcium hydride, CaH₂) is preferably contained in an interior compartment 26 of the hollow tubing 22. The gas producing agent 24 preferably produces a gas (e.g. oxygen, carbon dioxide, etc.) when in contact with water. The engine 16 is capped at one or both ends. In FIG. 2, an end portion 28 of the engine 16 includes a removable cap member 30 that provides access to small orifice 32 (see FIG. 3) when removed, thus providing access to the interior compartment 26. The cap member 30 may be formed by dipping, spray coating, or other coating techniques. The cap member 30 may include a polymer material such as vinyl, polyethylene, polypropylene, etc. The cap member 30 may inhibit water or other moisture from entering into the interior compartment 26 of the engine 16 and contacting the gas producing agent 24 until desired.

The engine 16 may be “activated” by removing the cap 30 and exposing the orifice 32 prior to inserting the engine 16 is inserted into the cavity 14. When the crawfish 2 is subsequently placed in a body of water, water may enter the interior compartment 26 via the orifice 32 and then contact the gas producing agent 24. A chemical reaction may then take place between the water and the gas producing agent 24 to thereby produce gas as a product.

Turning to FIG. 4, gas stream 34 is illustrated being released from the engine 16 (contained within a differently shaped and configured bait) through the orifice 26. Water is prevented from entering the cavity interior compartment 32 through the orifice 26 at the same time the gas stream 34 is exiting the interior compartment 32 through the orifice 26. As such, the release of gas through the orifice 26 preferably regulates/meters entry of water through the orifice 26.

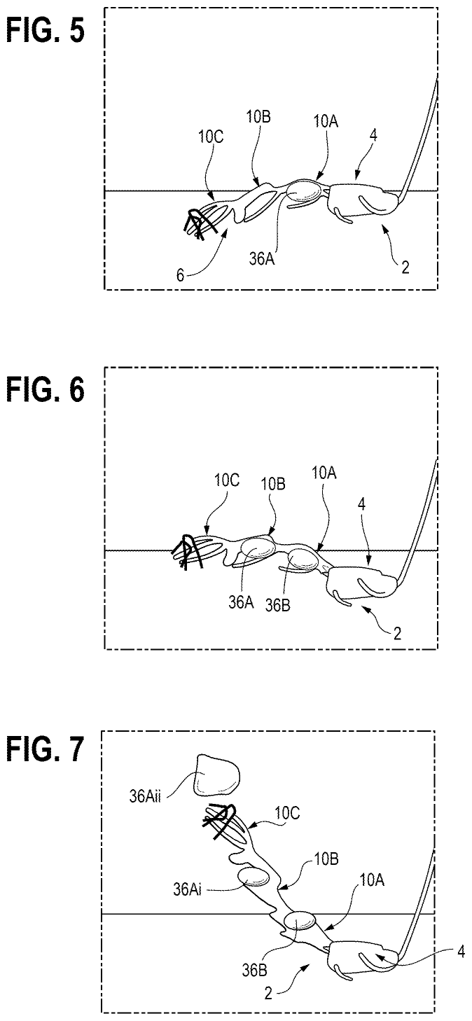

The stream 34 is represented as tiny bubbles rising from the orifice 26. The gas may be released from the engine 16, the cavity 14, or may consolidate, in the form of independent bubbles (see FIGS. 5-7), which may be of any size, as desired. The bubbles that are formed independently or make up the stream 34 may contact a portion of the crawfish 2 (or other autonomous bait design) and cause that portion to move in an autonomous manner. From the perspective of a fish, the autonomous movement may make the crawfish 2 (or other autonomous bait) appear to be a live food source for the fish, and thus attract the fish.

The size of the orifice 26 and the amount of gas producing agent 24 may be provided at a particular ration or amount on order to produce a desired amount of gas for a desired amount of time. That is, the orifice 26 may be of a specific depth and/or diameter, and the gas producing agent 24 may be of a specific composition and/or amount so as to properly meter the chemical reaction (by metering the exit of gas and entry of water through the orifice 26) to control both the amount of gas produced and the duration of gas production. The size of the orifice 26 may also be tailored so that certain size bubbles are released from the engine 16.

In one embodiment, the orifice 26 may be about 1.5 mm in diameter. The orifice 26 may be created during production of the engine 16, or post-production and just before the engine 16 is inserted into the cavity 14, or the orifice 26 may be enlarged after the cap 30 is removed to increase gas output from the engine 16.

Once the gas producing agent 24 in the engine 16 is consumed, so that no more gas is produced by the engine 16, the spent engine 16 may be taken out of the cavity 14 and replaced with a new engine 16. Alternatively, additional gas producing agent may be added to the spent engine 16 such that it can be used again.

Operation and movement of the crawfish 2 is described with reference to FIGS. 5-7. Turning first to FIG. 5, the crawfish 2 includes three articulating segments 10A, 10B, 10C, that make up the tail portion 6 of the crawfish 2. More or fewer segments 10 can be included on the crawfish 2, as embodied by the four segments 10 illustrated in FIG. 1.

At the beginning of a cycle of operation of autonomous movement, the three segments 10A, 10B, 10C are bowed downwardly within the water their own weight. The segments 10A, 10B, 10C preferably include capture portions (not illustrated) that have an upside down bowl or pocket shape configured to capture the gas released from the engine 16 (which is not illustrated in FIGS. 5-7) positioned within the main body 4.

As the engine 16 operates to release gas, the released gas may accumulate as a first bubble 36A, which is captured under the first segment 10A. The first bubble 36A may increase size as more gas is release from the engine 16. As the first bubble 36A grows larger as it accumulates more of the released gas, it becomes buoyant enough to lift up the first segment 10A relative to the main body 4, and thereby the other segments 10B and 10C attached thereto, at least to a certain degree.

As illustrated in FIG. 6, as the tail portion 6 lifts relative to the main body 4, the first bubble 36A may travel rearwardly further toward the tail portion until it is captured under the second segment 10B, thus moving the second segment 10B relative to the first segment 10A. Concurrently, a second bubble 36B may be formed and captured under the first segment 10A. The movement of the first bubble 36A to the second segment 10B and the creation of the second bubble 36B provides additional buoyancy to the tail portion 6, and thus lifts up the tail portion 6 even more as compared to the main body 4, as illustrated in FIG. 7.

When additional gas is produced, the first bubble 36A is transferred to and captured under the third segment 10C, which moves the third segment 6C with respect to the second segment 6B. The third segment 10C is lifted up even more such that the first bubble 36A is then released from the third segment 10C and floats up through the water.

In the embodiment illustrated in FIG. 7, the first bubble 36A may separate into a small portion 36Ai, which may remain captured under the second segment 10B, and a larger portion 36Aii, which may be released from the third segment 10C. In this scenario, the small portion 36Ai may combine with the second bubble 36B when the second bubble 36B is subsequently transferred to the second segment 10B.

When the first bubble 36A, or just the larger portion 36Aii of the first bubble 36A, is released from the third segment 10C, the tail portion 4 including the segments 10A, 10B, 10C may sink back down in the water with respect to the main body 4 under the influence of its own weight. The crawfish 2 may thereby again assume the bowed arrangement of FIG. 5 before the cycle repeats as more bubbles are produced. In the embodiment described herein for the crawfish 2, the bubble 36 preferably directly impinges upon the segments 10 of the tail portion 4 of the crawfish 2 so as to only substantially move the tail portion 6 relative to the main body 4.

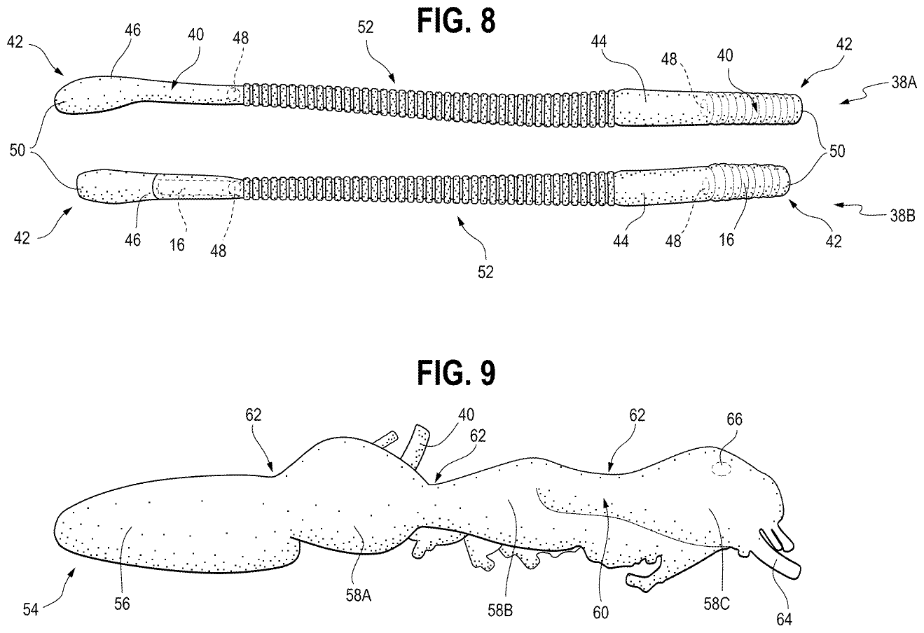

FIG. 8 provides a second embodiment of an autonomous bait in the form of two artificial worms 38A and 38B. The top worm 38A does not illustrate any engines 16 so that cavities 40 that retain the engines 16 can be indicated, while the bottom worm 38B illustrates the engines 16 received and secured within the cavities 10. The artificial worms 38A and 38B may generally be similarly made from a solid polymer material, and they include two cavities 40 at their distal end portions 42, each being configured to house an engine 16. The worms 38A and 38B preferably include a head 44 and a tail 46 at opposite ends of one another. They also preferably include two counterweights 48 arranged in the head 44 and the tail 46, respectively.

The worms 38A and 38B may include two engines 16 arranged in the cavities 40 of the worms 38A and 38B and nearer to the end portions 42 of the worms 38A and 38B than the counterweights 46 are to the end portions 42. The engines 16 may be inserted into the cavities 40 through openings 50 at the end portions 42. Gas produced by the engines 16 may be released through the openings 50 to generate movement of the worms 38A and 38B.

In an embodiment, the gas released from the engines 16 may temporarily accumulate in the two cavities 40, thus creating buoyancy in the head 44 and the tail 46 of the worms 38A and 38B, thus causing the two end portions 42 of the worms 28A and 38B to rise in the water with respect to a main body 52 of the worms 38A and 38B between the head 44 and tail 46. Once the end portions 42 of the worms 38A and 38B rise, the accumulated gas may be release from the cavities 40 through the openings 50. Having lost the buoyancy from the accumulated gas, the counterweights 48 may then cause the end portions 42 to sink again in the water with respect to the main body 52, and the cycle can repeat itself. Such movement mimics movement of live worms/night crawlers, and thus fish may be attracted to the worms 38A and 38B.

The placement of the counterweights 48 may be adjusted along the length of the worms 38A and 38B to adjust their movement through the cycle of rising and sinking. The distance of the engines 16 from the openings 50 may be adjusted, and this distance may help determine how much gas will accumulate in the cavities 40 before being released out of the openings 50 and will further determine the reaction rate of the gas producing agent 24 with water. This distance may be about 1-10 mm from the openings 50.

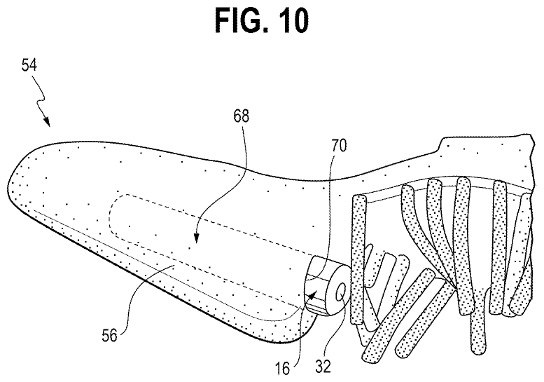

FIG. 9 illustrates an artificial bait in the form of a shrimp 54. The shrimp 54 is includes a head 56 and articulating segments 58A, 58B, and 58C that make up a tail portion 60. Segments 58A, 58B, and 58C are connected to each other and to the head 56 by moveable joints 62 that include the same material as makes up the other portions of the shrimp 54 and thus are integral with the other portions of the shrimp 54. The joints 62, however, have a reduced cross-sectional area compared to the head 56 or segments 58 to allow articulation of the segments 58A, 58B, 58C with respect to each other and to the head 56. More or fewer segments 58 may be included on the shrimp 54. Legs 64 may be attached to each of the segments 58A, 58B, 58C to add to the shrimp-like appearance. The third segment 58C also preferably includes a counterweight 66.

Turning now to FIG. 10, the engine 16 is arranged in a cavity 68, which itself is arranged in the head 56 and has an opening 70 facing a rear of the shrimp 54. The engine 16 is inserted into the cavity 68 as depicted in FIG. 10 such that a portion of the engine 16 sticks out from the cavity 68. However, this arrangement is not required, and the entire engine 16 could be contained within the cavity 68.

When the shrimp 54 is submerged in water, the engine 16 will produce gas, which is released from the orifice 32 towards the segments 58A, 58B, and 58C. As with the crawfish 2, each of the segments 58A, 58B, and 58C of the shrimp 54 preferably include a capture portion (not illustrated) having a shape configured to capture the gas released from the engine 16. The shrimp 54 may experience cycles of movement due to the release of gas from the engine 16, similarly to that as described with respect to the crawfish 2 in FIGS. 5-7. As such, at the beginning of each cycle, the segments 58 of the shrimp 54 may be bowed down. This bowed arrangement may be facilitated by the counterweight 66 in the third segment 58C. However, the released gas is successively captured as bubbles accumulate under the segments 58A, 58B, and 58C and then are released to cyclically raise and sink the segments 58A, 58B, and 58C with respect to the head 56 and thereby mimic the movement of a live shrimp. The counterweight 66 helps to facilitate the sinking of the segments 58 of the shrimp 54 and may also allow the bubbles to successively translate through each segment 58. Articulation of the segments 58 may be modified by changing the location or weight of the counterweight 66. The shrimp 54 may be used with a jig head inserted through the head 56 for catching fish.

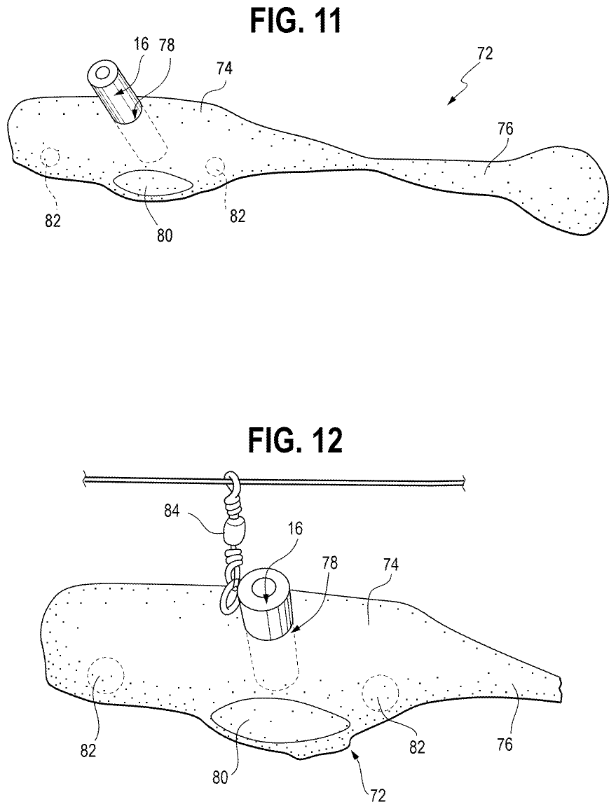

FIGS. 11 and 12 illustrate yet another embodiment of an artificial bait that is embodied as a minnow 72. The minnow 72 preferably includes a main body 74 and tail 76 extending rearwardly from the main body 74. The engine 16 may be positioned and located in a cavity 78 within the main body 74. The engine 16 may be inserted from the top of the main body 74 into the cavity 78 with the orifice 26 (not illustrated in FIG. 11) facing down. Thus, the orifice 26 is arranged at the bottom of the main body 74. The main body 74 preferably includes a capture portion 80 at the bottom of the main body 74 that has a shape (such as an upside down bowl or pocket) configured to capture the gas released from the engine 16. The minnow 72 may further include two counterweights 82, one each arranged in front of and behind the capture portion 80, respectively.

In operation, when the minnow 72 is submerged in water, the engine 16 may produce and release gas from the orifice 26. The released gas may be captured under the capture portion 80 and produce buoyancy at or near the middle of the main body 74, thus causing the minnow 72 to tip/tilt from side to side and/or front to back with respect to a point at which a swivel 84 (see FIG. 12) is attached to the main body 74. When the minnow 72 tips, the captured gas may be released from the capture portion 80 and float up through the water. The counterweights 82 will preferably help balance the minnow 72 after it is tipped and bring the minnow 72 back to level after the gas is released. Thereafter, the cycle will start again with more gas being released from the engine 16.

The orifice 26 on the engine 16 may be arranged within the cavity 78 of the minnow 72, or it may stick out from the cavity 78. Adjusting the arrangement of the orifice 26 with respect to the cavity 78, and adjusting the point at which the swivel 84 is attached to the main body 74 of the minnow 72, will preferably affect the movement of the minnow 72 that results from the gas being generated by the engine 16.

In the various embodiments described herein, the jig head and/or hook may be specifically positioned to balance the artificial baits. In some embodiments, the jig head and hook may even be co-molded to form a single structure. In such an embodiment, a visual line may be provided on the exterior of the bait showing the proper path of the jig head and/or hook within the bait to maintain balance.

It will be appreciated that various of the above-disclosed embodiments and other features and functions, or alternatives or varieties thereof, may be desirably combined into many other different systems or applications. Also, various presently unforeseen or unanticipated alternatives, modifications, variations or improvements therein may be subsequently made by those skilled in the art which are also intended to be encompassed by the following claims.

1. An autonomous bait comprising:
a main body including at least one cavity;
an engine arranged in the at least one cavity, the engine including:
an orifice providing access to an interior compartment of the engine;
a gas producing agent arranged in the interior compartment and configured to generate gas upon exposure to water; and
wherein the orifice is configured to allow water to enter into the interior compartment and to allow the generated gas to exit out of the interior compartment.

2. The autonomous bait of claim 1, wherein the autonomous bait further includes articulating segments moveably attached in series to the main body.

3. The autonomous bait of claim 2, wherein the articulating segments each include a capture portion having a shape configured to capture the generated gas released from the engine and thus cycle through movements with respect to the main body upon capturing and releasing the generated gas.

4. The autonomous bait of claim 3, further including a counterweight embedded in one of the articulating segments most distal from the main body.

5. The autonomous bait of claim 1, wherein the gas producing agent is at least one of calcium hydride and CaH2.

6. The autonomous bait of claim 1, wherein the autonomous bait is configured as one of a crawfish, shrimp, worm, or minnow.

7. The autonomous bait of claim 1, wherein the autonomous bait includes two cavities.

8. An autonomous bait comprising:
a main body,
a head at a first end of the main body and including a first cavity,
a first engine arranged in the first cavity, the first engine including:
an orifice providing access to an interior compartment of the first engine;
a gas producing agent arranged in the interior compartment and configured to generate gas upon exposure to water; and
wherein the orifice is configured to allow water to enter into the interior compartment and to allow the generated gas to exit out of the interior compartment.

9. The autonomous bait of claim 8, wherein the autonomous bait includes a second cavity at a second end of the main body.

10. The autonomous bait of claim 9, wherein the second cavity includes a second engine arranged in the second cavity.

11. The autonomous bait of claim 10, wherein the second engine includes:
an orifice providing access to an interior compartment of the second engine;
a gas producing agent arranged in the interior compartment and configured to generate gas upon exposure to water; and
wherein the orifice is configured to allow water to enter into the interior compartment and to allow the generated gas to exit out of the interior compartment.

12. The autonomous bait of claim 8, wherein the autonomous bait includes a first counterweight embedded therein.

13. The autonomous bait of claim 9, wherein the autonomous bait includes a first counterweight arranged in the head and a second counterweight arranged in the second end of the autonomous bait.

14. The autonomous bait of claim 13, wherein the first counterweight and the second counterweight are closer to each other than are the first and second engines.

15. An engine for use in an autonomous bait, the engine comprising:
an orifice providing access to an interior compartment of the engine;
a gas producing agent arranged in the interior compartment and configured to generate gas upon exposure to water;
wherein the orifice is configured to allow water to enter into the interior compartment and to allow the generated gas to exit out of the interior compartment.

16. The engine of claim 15, wherein the engine is positioned and located in a cavity of a main body of the autonomous bait.

17. The engine of claim 15, wherein the gas producing agent is at least one of calcium hydride and CaH2.

18. The engine of claim 15, wherein the engine is cylindrical in shape.

19. The engine of claim 15, wherein the engine includes a cap member that is selectively engageable with the engine so as to cover and uncover the orifice.

20. The engine of claim 15, wherein the orifice is between 1 mm and 2 mm in diameter.
